(19) United States
(12) Patent Application Publication
(10) Pub. No.: US 2009/0297875 A1
(43) Pub. Date: Dec. 3, 2009

(54) SCULPTURE KIT

(76) Inventor: SHEILA ADAMS HART, Redmond, WA (US)

Correspondence Address: SHEILA ADAMS HART, 26230 NE 34TH STREET, REDMOND, WA, 98053, US

(21) Appl. No.: 12/474,181

(22) Filed: May 28, 2009

Related U.S. Application Data
(60) Provisional application No. 61/056,733, filed on May 28, 2008.

(51) Int. Cl. B32B 1/08

(52) U.S. Cl. 428/603

(57) ABSTRACT

A sculpting coil segment, a system, and a kit including sculpting coil segments and couplers is described in accordance with exemplary embodiments of the invention. Sculpting coil segments may comprise a distensible, flexible hollow metal body shaped into a coil, a first coil segment end and a second coil segment end wherein the first coil segment end is connectable to the second coil segment end. In a system or kit, a plurality of couplers may adjoin adjacent sculpting segments to form an interconnection among the sculpting segments. In another exemplary embodiment, coiled sculpting segments may be powder-coated with desired colors and connected to form curvilinear sculptures.

### RELATED APPLICATIONS

This application claims the benefit of priority from U.S. Provisional Patent Application No. 61/056,733, filed on May 28, 2008.

### BACKGROUND OF THE INVENTION

The present invention generally relates to the field of sculpting, and more particularly, to a sculpting apparatus, kit, and system.

Sculpting is an art form that may create three dimensional shapes by manipulating the structure of solid materials. Manipulating the materials may require one to get dirty as materials such as metal, wood, stone, or the like are chipped, grinded, and pounded away at until a desired form is achieved. Additionally, some of these sculpting mediums may require the use of sharp and heavy tools such as chisels or the use of heated tools such as a welder's torch. Thus, in some cases, sculpting, while rewarding, can be daunting for the lay artist because of the resources required. Moreover, younger artists may be prevented from working with the tools necessary to sculpt because of the risks involved.

As can be seen, there is a need for a sculpting apparatus and system that facilitates artistry in sculpting by a lay artist or child.

### SUMMARY OF THE INVENTION

In one aspect of the present invention, a sculpting coil segment, comprises, a distensible, flexible, coil-shaped hollow body; a first coil segment end; and a second coil segment end wherein the first coil segment end is connectable to the second coil segment end.

In another aspect of the present invention, a sculpting kit, comprises one or more sculpting segments, each sculpting segment respectively including a distensible and flexible body and first and second segment ends; and one or more couplers, wherein each coupler respectively includes at least one coupler end for receiving either the first or the second segment end of respective sculpting segments to form an interconnection among the one or more sculpting segments.

These and other features, aspects and advantages of the present invention will become better understood with reference to the following drawings, description and claims.

### BRIEF DESCRIPTION OF THE DRAWINGS

FIG. 1A is a perspective view of a sculpting coil segment in accordance with an exemplary embodiment of the present invention;

FIG. 1B depicts a coupling employed in accordance with an exemplary embodiment of the present invention;

FIGS. 1C and 1D depict a coupling employed in a system according to another exemplary embodiment of the present invention;

FIG. 2A depicts a system illustrating an artist's rendition employing a plurality of the sculpting coil segment shown in FIG. 1A; and

FIG. 2B depicts another system employing a single sculpting coil segment shown in FIG. 1A according to another artistic rendition.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features. However, any single inventive feature may not address any of the problems discussed above or may only address one of the problems discussed above. Further, one or more of the problems discussed above may not be fully addressed by any of the features described below.

Broadly, embodiments of the present invention generally provides a sculpting coil for use in a sculpture kit that provides a system of interconnected coil segments that can be manipulated and formed into shapes of a user's choosing. The sculpting coil segments may be sturdy, flexible and re-shapeable permitting the erection of one artistic design to be disassembled and re-assembled into another design at will. Structures created by use of the sculpture kit may be freestanding and environmentally resistant thus, permitting use in both indoor and outdoor environments. Exemplary environments one may employ the sculpture kit include educational settings for both children and adults, corporate team building exercises, rehabilitation training for those of mentally degrading health, and in audience participation settings.

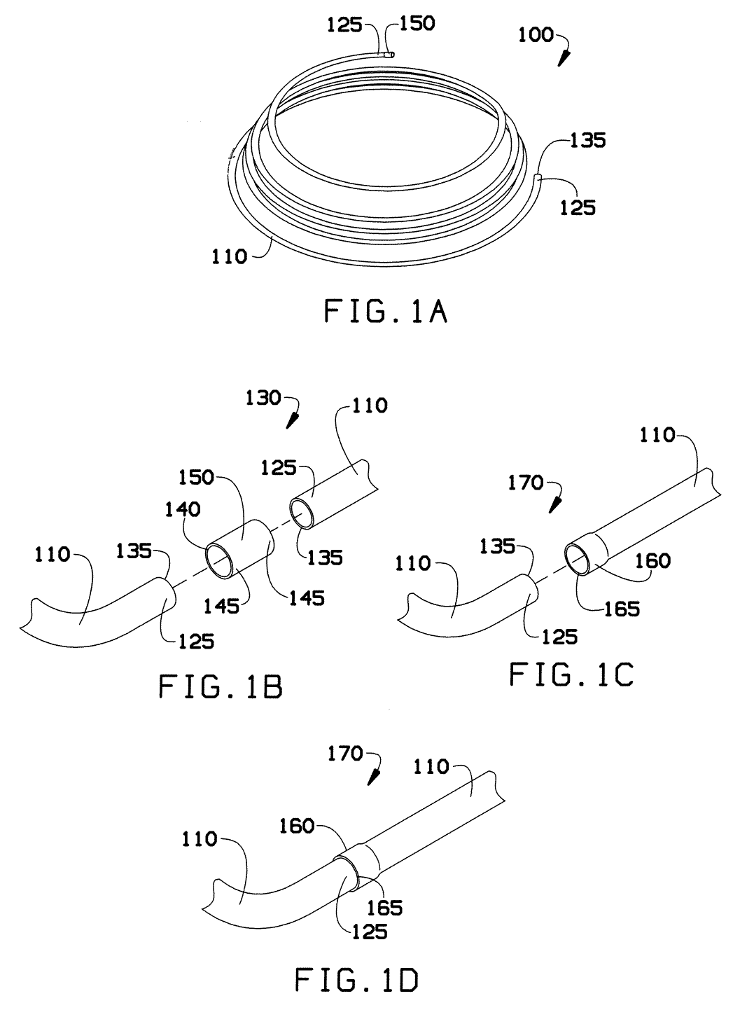

Referring now to FIGS. 1A-1D, a kit may include one or more sculpting coil segments 100. The sculpting coil segment 100 may comprise a body 110 with ends 125. The body 110 may be a single length of flexible, hollow cylindrical material such as metal that can be distended into desired forms. Embodiments using a metal construction may include the use of aluminum or copper. The body 110 may be powder coated in a variety of colors including chromatic and metallic hues. The length of the body 110 may be varied to accommodate for adjustments in the curvi-linearity of a sculpted design. For instance, in one exemplary embodiment using a standardized length of sculpting coil segments 100, the length of a body 110 may be 12 feet 6 inches long or in another option, 25 feet long. The outside diameter 135 of a body 110 may be ⅜ inches to ½ inches wide. The diameter and coil shape of each sculpting coil segment 100 may be conducive to stacking one upon another for storage and shipping.

Referring specifically to FIGS. 1B-1D, alternative embodiments illustrating exemplary coupling are shown. In FIG. 1B, a coupling 130 is shown employing a coupler 150 adjoining two adjacent ends 125. It will be understood that the ends 125 may be either from a single sculpting coil segment 100 or from two separate sculpting coil segments 100. In this exemplary embodiment, the coupler 150 may be a non-flexing, hollow, and cylindrical unit with an inner diameter 140 that is wider than the outer diameter 135 of the adjacent coil bodies 110 and their respective ends 125. One exemplary coupler 150 may be a 1 inch long piece of copper with an inner diameter opening of ⅜ inches. The ends 125 may be press fit into each coupler end 145 providing a secure yet, separable coupling 130 should a user wish to deconstruct a sculpture and reconfigure it. For more permanent structures, the coupling 130 may use an epoxy to secure the ends 125 with the coupler 150.

In FIGS. 1C and 1D, an alternate exemplary embodiment of a connection depicting a coupling 170 is illustrated. In this embodiment, a splating technique is shown. One coil body 110 includes the end 125 with an outer diameter 135 as shown in FIG. 1B. The other coil body 110 includes a splated end 160 that is formed by expanding an inner diameter 165 of the splated end 160 so that the inner diameter 165 is formed just wider than the outer diameter 135 of the end 125 to permit a press fit of the end 125 into the end 160. It will be understood that the end 125 would not be powder-coated or painted on to facilitate entry into the splated end 160.

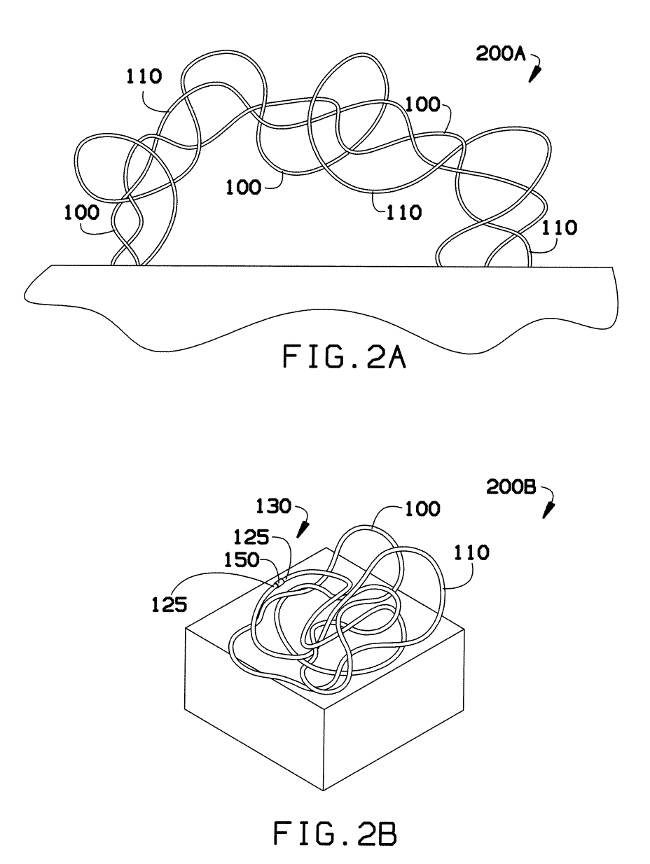

Referring now to FIGS. 2A and 2B, exemplary system embodiments 200A and 200B include one or more sculpting coil segments 100 which may be formed into sculptures as depicted. For example, in FIG. 2B, a system 200B is shown employing a single sculpting coil segment 100 wound and formed into a generally spherical sculpture where a coupling 130 is formed by connecting respective first and second ends 125 of the single coil segment 100 together by means of a coupler 150. The material construct of each sculpting coil segment 100 allows a user to expand, flex, twist, and stretch each sculpting coil segment 100 into a variety of curvilinear forms. For example, as can be seen, in FIG. 2A, the tension of adjacent sculpting coil segments 100 by their ends 125 and the tensile strength of the bodies 110 may provide self-supported arching. In FIG. 2A, the system 200A may include a plurality of sculpting coil segments 100 cooperating to form a generally arch-shaped sculpture. Each individual coil segment 100 may be formed into an arch or a plurality of coil segments 100 may be adjoined together by the couplings 130 to form an arch. Thus, the tensile strength of each body 110 which may be reinforced by the couplings 130 may allow a sculpture to remain free-standing without additional support. Furthermore, when a user wishes to breakdown a sculpture, each sculpting coil segment 100 may be separated from a coupling 130 by slidably removing and end 125 from the coupler 150. Upon disengagement of the end 125 from the coupling 130, the body 110 may be reformed back into a coil shape for ease of storage and future sculpting.

It will be understood that while embodiments have been described in the context of powder-coated and metallic finished bodies 110, that other aesthetic exterior designs may be employed such as the use of paint, stickers, ribbon, yarn, fabric, lighting, vines, paper, or feathers. Additionally, while embodiments have been described as using aluminum or copper, it will be understood that other suitable metals may be employed that permit coiling and distending of the body 110 into sculpted forms. Also, while the sculpting segment coil body has been described as generally cylindrical, it will be understood that other shapes may also be used.

It should be understood, of course, that the foregoing relates to exemplary embodiments of the invention and that modifications may be made without departing from the spirit and scope of the invention as set forth in the following claims.

We claim:

1. A sculpting coil segment, comprising:
a distensible, flexible, coil-shaped hollow body;
a first coil segment end; and
a second coil segment end wherein the first coil segment end is connectable to the second coil segment end.

2. The sculpting coil segment of claim 1, wherein the body may be power-coated.

3. The sculpting coil segment of claim 1, wherein the first coil segment end and the second coil segment end are connected together via a coupler.

4. The sculpting coil segment of claim 1, wherein:
the first coil segment end includes an outer diameter;
the second coil segment end is splated to include an inner diameter thinner than the first segment coil end outer diameter wherein the outer diameter of the first coil segment end is insertable into the inner diameter of the splated second coil segment end.

5. A sculpting kit, comprising:
one or more sculpting segments, each sculpting segment respectively including a distensible and flexible body and first and second segment ends; and
one or more couplers, wherein each coupler respectively includes at least one coupler end for receiving either the first or the second segment end of respective sculpting segments to form an interconnection among the one or more sculpting segments.

6. The sculpting kit of claim 5 wherein each respective coupler is a hollow cylindrical unit including first and second open coupler ends wherein each coupler end includes an inner diameter that is wider than an outer diameter of each respective first and second segment ends.

7. The sculpting kit of claim 5 wherein each respective segment is coil-shaped.

8. The sculpting kit of claim 5 wherein the at least one coupler end is the second segment end and wherein the second segment end is splated with an inner diameter wider than an outer diameter of the first segment end.

9. The sculpting kit of claim 5 wherein each sculpting segment is reshapable.

10. The sculpting kit of claim 5 wherein the interconnection of sculpting elements forms a curvilinear sculpture.
